(19) United States
(12) Patent Application Publication
(10) Pub. No.: US 2025/0097911 A1
(43) Pub. Date: Mar. 20, 2025

(54) Channel Access Method and Apparatus

(71) Applicant: Huawei Technologies Co., Ltd., Shenzhen (CN)

(72) Inventors: Jian Yu, Shenzhen (CN); Wei Ruan, Shanghai (CN); Mengshi Hu, Shenzhen (CN); Ming Gan, Shenzhen (CN)

(21) Appl. No.: 18/962,258

(22) Filed: Nov. 27, 2024

Related U.S. Application Data
(63) Continuation of application No. PCT/CN2023/097135, filed on May 30, 2023.

(30) Foreign Application Priority Data
May 31, 2022 (CN) 202210616224.X

(51) Int. Cl. H04W 72/0446; H04W 74/0808

(52) U.S. Cl. CPC H04W 72/0446; H04W 74/0808

(57) ABSTRACT

This application provides a channel access method and an apparatus, and relates to the field of communication technologies, to resolve a problem that it is difficult for a long range communication device to access a channel, and communication efficiency is low. The method includes: A first device detects a channel status in first duration. If a channel is in an idle state, M is subtracted from a value of a first counter, where M is a positive integer greater than 1. If the value of the first counter is greater than 0, the first device detects the channel status in next first duration; or if the value of the first counter is less than or equal to 0, the first device transmits data through the channel.

### CROSS-REFERENCE TO RELATED APPLICATIONS

This application is a continuation of International Application No. PCT/CN2023/097135, filed on May 30, 2023, which claims priority to Chinese Patent Application No. 202210616224.X, filed on May 31, 2022. The disclosures of the aforementioned applications are hereby incorporated by reference in their entireties.

### TECHNICAL FIELD

This application relates to the field of communication technologies, and in particular, to a channel access method and an apparatus.

### BACKGROUND

In a wireless local area network (wireless local area network, WLAN) technology, the 802.11 standard of the Institute of Electrical and Electronics Engineers (institute of electrical and electronics engineers, IEEE) includes a wireless fidelity (wireless fidelity, Wi-Fi) technology. The Wi-Fi technology generally involves two types of devices: an access point (access point, AP) and a station (station, STA). The AP may also be referred to as a wireless access point, and is configured to: provide a WLAN network, allow another wireless device to access the WLAN network, and provide data access for the accessing device. A device that accesses the WLAN network may be referred to as the STA. User data is transmitted between the AP and the STA via a physical frame.

A WLAN device may operate on an unlicensed spectrum. Currently, a channel may be accessed in a manner like a distributed coordination function (Distributed Coordination Function, DCF), to ensure that no conflict or collision occurs in data receiving and sending between the AP and the STA. For example, a plurality of STAs that are to send data may generate random backoff parameters, and each STA needs to perform clear channel assessment (Clear Channel Assessment, CCA) within specific detection time. When the STA determines that a channel is idle and a value of a random backoff counter is 0, the STA may access the channel to perform data exchange.

However, for a long range WLAN communication scenario, due to factors such as signal power attenuation and noise interference caused by long range transmission, a backoff waiting mechanism on which both a long range communication device and a common device are based is no longer applicable. However, currently, there is no channel access method for a long range communication WLAN device, and consequently, long range communication efficiency is low

### SUMMARY

This application provides a channel access method and an apparatus, to resolve a problem, in a conventional technology, that it is difficult for a long range communication device to access a channel, and communication efficiency is low.

To achieve the foregoing objective, this application uses the following technical solutions.

According to a first aspect, a channel access method is provided. The method includes: A first device detects a channel status in first duration. If a channel is in an idle state, M is subtracted from a value of a first counter, where M is a positive integer greater than 1. If the value of the first counter is greater than 0, the first device detects the channel status in next first duration; or if the value of the first counter is less than or equal to 0, the first device transmits data through the channel.

In the foregoing technical solution, when performing random channel contention, a long range transmission node increases a backoff value of a counter each time in a random backoff process, so that the counter can be back off to 0 or a value less than 0 more quickly, thereby accelerating a backoff speed of the long range transmission node and ensuring fairness of random channel contention, and improving transmission efficiency of a long range device.

In an implementation, the first duration is greater than duration of a first time unit, and the first time unit is one slot. A channel detection window in a common transmission scenario is the first time unit, and the first duration of a channel detection window corresponding to the long range transmission node is greater than the first time unit, to ensure that a receive end in a long range transmission scenario can detect a received signal. In this scenario, M is subtracted from the first counter to accelerate backoff, so that the backoff speed of the long range transmission node can be accelerated, and the fairness of random channel contention performed by the long range transmission node can be ensured as much as possible.

In an implementation, before that a first device detects a channel status in first duration, the method further includes: The first device waits for a first inter-frame gap. The first inter-frame gap is a point coordination function inter-frame space PIFS of long range, a short inter-frame space SIFS, or a distributed coordination function inter-frame space DIFS of long range. Before performing random backoff to detect the channel status, the first device needs to wait for a fixed inter-frame space.

In an implementation, the long rangePIFS of long range is a sum of the SIFS and the first duration. In a foregoing long range communication scenario, the corresponding fixed inter-frame space is correspondingly increased based on the first duration of a random detection window. This helps a long range communication device to more accurately identify, during initial detection after a channel is busy, whether a signal exists on an air interface.

In an implementation, the long rangeDIFS of long range is a sum of the SIFS and twice the first duration. In a foregoing long range communication scenario, the corresponding fixed inter-frame space is correspondingly increased based on the first duration of a random detection window. This helps a long range communication device to more accurately identify, during initial detection after a channel is busy, whether a signal exists on an air interface.

In an implementation, that the first device detects the channel status in next first duration specifically includes: The first device detects the channel status in the next first duration after an end moment of the first duration. Therefore, after the end moment of the 1st first duration, the first device may open a 2nd channel detection window whose length is the first duration to detect the current channel status. In this way, the value of the first counter is updated based on that it is detected that the channel is in the idle state, and backoff is performed, so that fast backoff of the long range transmission node is implemented, and a channel access opportunity is obtained fairly.

In an implementation, the method further includes: The first device sends a long range physical layer protocol data unit PPDU through the channel.

According to a second aspect, a channel access method is provided. The method includes: A first device detects a channel status in first duration, and if the channel status is an idle state, subtracts M from a value of a first counter, where M is a positive integer. The first device opens one channel detection window at an interval of a second time unit after a start moment of the first duration, detects the channel status in the channel detection window, and if the channel status is the idle state, subtracts M from the value of the first counter, where M is the positive integer. If the value of the first counter is less than or equal to 0, the first device transmits data through the channel.

In the foregoing technical solution, a sliding window manner is used. After the start moment of the 1st channel detection window of the first duration, one channel detection window is opened at the interval of the second time unit, so that a long range device can open a plurality of channel detection windows in parallel, and detect channel statuses at the same time. When it is detected in one channel detection window that a current channel is in the idle state, M may be subtracted from the value of the first counter. When it is detected in the plurality of channel detection windows that the current channel is in the idle state, M may be subtracted from the value of the first counter for a plurality of times. This accelerates CCA detection frequency and a backoff speed of the long range device, so that the first counter can be quickly back off to 0 or a value less than 0, thereby accelerating a backoff speed of a long range transmission node. This ensures fairness of random channel contention performed by the long range transmission node, and improves transmission efficiency of the long range device.

In an implementation, duration of the channel detection window is equal to the first duration. The plurality of channel detection windows of the first duration are opened in parallel in the sliding window manner, so that CCA detection frequency of the long range transmission node and the backoff speed of the counter can be accelerated.

In an implementation, the first duration is greater than duration of a first time unit, and the first time unit is one slot. A channel detection window corresponding to long range transmission is longer than a channel detection window in a common transmission scenario. In this case, fast decreasing backoff is implemented on the first counter in a parallel detection manner in which a sliding window is used, so that the backoff speed of the long range transmission node can be accelerated, and the fairness of random channel contention performed by the long range transmission node can be ensured as much as possible.

In an implementation, if a current frame corresponds to a point coordination function inter-frame space PIFS of long range or a distributed coordination function inter-frame space DIFS of long range, that a first device detects a channel status in first duration specifically includes: After a short inter-frame space SIFS, the first device starts to detect the channel status in the first duration. In other words, the first device may occupy, after the short inter-frame space SIFS, idle duration, to open, in advance, the plurality of parallel channel detection windows for random backoff, thereby accelerating a backoff process of the long range node, and improving flexibility and access efficiency of channel access.

In an implementation, the method further includes: The first device sends a long range physical layer protocol data unit PPDU through the channel.

According to a third aspect, a channel access method is provided and applied to a second device. The method includes: sending a physical layer protocol data unit PPDU to a third device, where the PPDU includes indication information, and the indication information indicates the third device to send a trigger-based long range PPDU; and receiving the long range PPDU from the third device.

In the foregoing implementation, the indication information indicating to trigger the long range PPDU is added to the PPDU, so that a trigger frame with low overheads is implemented, and overheads of long range transmission are reduced. In this way, a receive end may send the long range PPDU based on the trigger frame, thereby improving communication efficiency of the long range transmission.

In an implementation, the indication information is carried in an extended signaling field or a data field of the PPDU.

According to a fourth aspect, a channel access method is provided and applied to a third device. The method includes: receiving a physical layer protocol data unit PPDU from a second device, where the PPDU includes indication information, and the indication information indicates the third device to send a trigger-based long range PPDU; and sending the long range PPDU to the second device.

In an implementation, the indication information is carried in an extended signaling field or a data field of the PPDU.

According to a fifth aspect, a communication apparatus is provided. The communication apparatus includes a processing module and a transceiver module. The processing module is configured to detect a channel status in first duration. If the channel is in an idle state, the processing module is further configured to subtract M from a value of a first counter, where M is a positive integer greater than 1. If the value of the first counter is greater than 0, the processing module is configured to detect the channel status in next first duration; or if the value of the first counter is less than or equal to 0, the transceiver module is configured to transmit data through the channel.

In an implementation, the first duration is greater than duration of a first time unit, and the first time unit is one slot.

In an implementation, the processing module is configured to: after waiting for a first inter-frame gap, detect the channel status in the first duration, and the first inter-frame gap is a point coordination function inter-frame space PIFS of long range, a short inter-frame space SIFS, or a distributed coordination function inter-frame space DIFS of long range.

In an implementation, the long rangePIFS of long range is a sum of the SIFS and the first duration.

In an implementation, the long rangeDIFS of long range is a sum of the SIFS and twice the first duration.

In an implementation, the processing module is configured to detect the channel status in next first duration after an end moment of the first duration.

In an implementation, the transceiver module is configured to send a long range physical layer protocol data unit PPDU through the channel.

According to a sixth aspect, a communication apparatus is provided. The communication apparatus includes a processing module and a transceiver module. The processing module is configured to: detect a channel status in first duration, and if a channel status is in an idle state, subtract M from a value of a first counter, where M is a positive integer. The processing module is further configured to: open one channel detection window at an interval of a second time unit after a start moment of the first duration, detect the channel status in the channel detection window, and if the channel status is the idle state, subtract M from the value of the first counter, where M is the positive integer. If the value of the first counter is less than or equal to 0, the transceiver module is configured to transmit data through the channel.

In an implementation, duration of the channel detection window is equal to the first duration.

In an implementation, the first duration is greater than duration of a first time unit, and the first time unit is one slot.

In an implementation, if a current frame corresponds to a point coordination function inter-frame space PIFS of long range or a distributed coordination function inter-frame space DIFS of long range, the processing module is configured to: after a short inter-frame space SIFS, start to detect the channel status in the first duration.

In an implementation, the transceiver module is further configured to send a long range physical layer protocol data unit PPDU through the channel.

According to a seventh aspect, a communication apparatus is provided. The communication apparatus includes a transceiver module, configured to send a physical layer protocol data unit PPDU to a third device. The PPDU includes indication information, and the indication information indicates the third device to send a trigger-based long range PPDU. The transceiver module is further configured to receive the long range PPDU from the third device.

In an implementation, the indication information is carried in an extended signaling field or a data field of the PPDU.

According to an eighth aspect, a communication apparatus is provided. The communication apparatus includes a transceiver module, configured to receive a physical layer protocol data unit PPDU from a second device. The PPDU includes indication information, and the indication information indicates the third device to send a trigger-based long range PPDU. The transceiver module is further configured to send the long range PPDU to the second device.

In an implementation, the indication information is carried in an extended signaling field or a data field of the PPDU.

According to a ninth aspect, a communication apparatus is provided. The communication apparatus includes a processor and a communication interface. The communication interface is configured to communicate with a module other than the communication apparatus, and the processor is configured to run a computer program or instructions, to implement the method according to any one of the implementations of the first aspect.

According to a tenth aspect, a communication apparatus is provided. The communication apparatus includes a processor and a communication interface. The communication interface is configured to communicate with a module other than the communication apparatus, and the processor is configured to run a computer program or instructions, to implement the method according to any one of the implementations of the second aspect.

According to an eleventh aspect, a communication apparatus is provided. The communication apparatus includes a processor and a communication interface. The communication interface is configured to communicate with a module other than the communication apparatus, and the processor is configured to run a computer program or instructions, to implement the method according to any one of the implementations of the third aspect.

According to a twelfth aspect, a communication apparatus is provided. The communication apparatus includes a processor and a communication interface. The communication interface is configured to communicate with a module other than the communication apparatus, and the processor is configured to run a computer program or instructions, to implement the method according to any one of the implementations of the fourth aspect.

According to a thirteenth aspect, a computer-readable storage medium is provided. The computer-readable storage medium includes a computer program. When the computer program is run on a computer, the computer is enabled to perform the method according to any one of the first aspect or the implementations of the first aspect.

According to a fourteenth aspect, a computer-readable storage medium is provided. The computer-readable storage medium includes a computer program. When the computer program is run on a computer, the computer is enabled to perform the method according to any one of the first aspect or the implementations of the second aspect.

According to a fifteenth aspect, a computer-readable storage medium is provided. The computer-readable storage medium includes a computer program. When the computer program is run on a computer, the computer is enabled to perform the method according to any one of the first aspect or the implementations of the third aspect.

According to a sixteenth aspect, a computer-readable storage medium is provided. The computer-readable storage medium includes a computer program. When the computer program is run on a computer, the computer is enabled to perform the method according to any one of the first aspect or the implementations of the fourth aspect.

According to a seventeenth aspect, a computer program product is provided. When the computer program product runs on a computer, the computer is enabled to perform the method according to any one of the first aspect or the implementations of the first aspect.

According to an eighteenth aspect, a computer program product is provided. When the computer program product runs on a computer, the computer is enabled to perform the method according to any one of the first aspect or the implementations of the second aspect.

According to a nineteenth aspect, a computer program product is provided. When the computer program product runs on a computer, the computer is enabled to perform the method according to any one of the first aspect or the implementations of the third aspect.

According to a twentieth aspect, a computer program product is provided. When the computer program product runs on a computer, the computer is enabled to perform the method according to any one of the first aspect or the implementations of the fourth aspect.

According to a twenty-first aspect, a communication system is provided. The communication system includes the communication apparatus according to any one of the seventh aspect or the implementations of the seventh aspect and the communication apparatus according to any one of the eighth aspect or the implementations of the eighth aspect.

It may be understood that any one of the communication apparatus, the computer-readable storage medium, the computer program product, and the communication system that are provided above may be implemented by using the corresponding methods provided above. Therefore, for beneficial effect that can be achieved by the communication apparatus, the computer-readable storage medium, the computer program product, and the communication system, refer to the beneficial effect in the corresponding methods provided above. Details are not described herein again.

### BRIEF DESCRIPTION OF DRAWINGS

FIG. 1 is a diagram of a parameter of a contention window according to an embodiment of this application;

FIG. 2 is a diagram of contending for a channel by using a random backoff mechanism according to an embodiment of this application;

FIG. 3 is a diagram of contending for a channel by a plurality of nodes by using a random backoff mechanism according to an embodiment of this application;

FIG. 4 is a composition diagram of several inter-frame spaces according to an embodiment of this application;

FIG. 5 is a diagram of a structure of a PPDU according to an embodiment of this application;

FIG. 6 is a diagram of a trigger-based and scheduling-based uplink transmission method according to an embodiment of this application;

FIG. 7 is a diagram of a system architecture of a communication system according to an embodiment of this application;

FIG. 8 is a diagram of a structure of a communication apparatus according to an embodiment of this application;

FIG. 9 is a schematic flowchart of a channel access method according to an embodiment of this application;

FIG. 10 is a diagram of a structure of a long range PPDU according to an embodiment of this application;

FIG. 11 is a diagram of a fast backoff method for long range transmission according to an embodiment of this application;

FIG. 12 is a schematic flowchart of a channel access method according to an embodiment of this application;

FIG. 13 and FIG. 14 are diagrams of fast backoff methods for long range transmission according to an embodiment of this application;

FIG. 15 is a schematic flowchart of another channel access method according to an embodiment of this application;

FIG. 16 is a diagram of a structure of a communication apparatus according to an embodiment of this application; and

FIG. 17 is a diagram of a structure of another communication apparatus according to an embodiment of this application.

### DESCRIPTION OF EMBODIMENTS

In the following description, the terms “first” and “second” are merely intended for a purpose of description, and shall not be understood as indicating or implying relative importance or implying a quantity of indicated technical features. Therefore, a feature limited by “first” or “second” may explicitly or implicitly include one or more features. In the description of embodiments, unless otherwise specified, “a plurality of” means two or more.

It should be noted that in this application, the term like “example” or “for example” represents giving an example, an illustration, or a description. Any embodiment or design scheme described as an “example” or “for example” in this application should not be explained as being more preferred or having more advantages than another embodiment or design scheme. Exactly, use of the word like “example” or “for example” is intended to present a related concept in a specific manner.

The following clearly describes the technical solutions in embodiments of this application with reference to the accompanying drawings in embodiments of this application. It is clear that the described embodiments are merely some but not all of embodiments of this application. All other embodiments obtained by a person of ordinary skill in the art based on embodiments of this application without creative efforts shall fall within the protection scope of this application.

For ease of understanding, the following first briefly describes technical terms in the embodiments of this application.

Embodiments of this application may be applicable to a wireless local area network (wireless local area network, WLAN) scenario, and may be applicable to an IEEE 802.11 system standard or a next-generation standard, for example, 7th generation WLAN systems (801.11, 802.11b, 802.11a/g, 802.11n, 802.11ac, 802.11ax, and 802.11be) that have been developed and popularized. Alternatively, embodiments of this application may be applicable to a wireless local area network system, for example, an Internet of things (internet of things, IoT) network or a vehicle-to-everything (Vehicle to X, V2X) network. In addition, embodiments of this application are also applicable to another possible communication system, for example, a long term evolution (long term evolution, LTE) system, an LTE frequency division duplex (frequency division duplex, FDD) system, an LTE time division duplex (time division duplex, TDD) system, a universal mobile telecommunications system (universal mobile telecommunications system, UMTS), a worldwide interoperability for microwave access (worldwide interoperability for microwave access, WiMAX) communication system, and a 5th generation (5th generation, 5G) communication system.

An access point (access point, AP) and a station (station, STA) related to a WLAN technology may be collectively referred to as a WLAN device or a node.

Currently, the WLAN device may operate on an unlicensed spectrum. Because of an exclusive feature of a radio channel, the channel may be randomly accessed in a distributed coordination function (Distributed Coordination Function, DCF) manner, to avoid a collision caused by that a plurality of nodes occupy the radio channel at the same time to send data. Random channel access may be implemented by using a carrier sense multiple access with collision avoidance (Carrier Sense Multiple Access with Collision Avoidance, CSMA/CA) mechanism.

In an implementation, when a node needs to send data, the node needs to perform sensing for a specific period of time, to perform clear channel assessment (Clear Channel Assessment, CCA). The CCA may determine a media status by using both a physical carrier sensing function and a virtual carrier sensing function. Only when determining, by using both the physical carrier sensing mechanism and the virtual carrier sensing mechanism, that a current channel is in an idle state, the node considers that the channel is idle. Otherwise, the node considers that the channel is busy.

The physical carrier sensing function is located at a physical layer (Physical layer, PHY), and whether media (media) is busy may be determined through energy detection (Energy Detection, ED) and preamble detection (Preamble Detection, PD). The virtual carrier sensing function is located at a media access control (Media Access Control, MAC) layer, and whether the channel is idle may be determined based on predetermined information carried in a duration (duration) field of a MAC frame header, where the information declares exclusive access to the media. The virtual carrier sensing function is referred to as a network allocation vector (Network Allocation Vector, NAV).

In the energy detection, signal energy received by the PHY layer is directly used to determine whether there is a signal for access. If signal strength is greater than ED_threshold, it is considered that the channel is busy. If signal strength is less than ED_threshold, it is considered that the channel is idle. In addition, setting of ED_threshold may be related to a transmit power. For example, if the transmit power is greater than 100 mW, ED_threshold is about −80 dBm; and if the transmit power is between 50 mW and 100 mW, ED_threshold needs to be −76 dBm.

The virtual carrier sensing is used to identify a preamble part in a physical layer header (PLCP header) of an 802.11 data frame. In brief, the preamble part in 802.11 is constructed by using a specific sequence. The sequence is known to both a sender and a receiver, and is used for frame synchronization and symbol synchronization. In an actual sensing process, a node continuously samples a channel signal, and uses the channel signal to perform an autocorrelation or cross-correlation operation. Similar to the energy detection, the node performs determining based on a calculated value of (auto/cross) correlation and a preset threshold. If the calculated value is greater than the threshold, it is considered that the signal is detected and a channel is busy. If the calculated value is less than the threshold, it is considered that no signal is detected and a channel is idle.

In the CSMA/CA, before one frame is sent, at least one corresponding inter-frame space needs to be waited for. For example, before data is sent, at least duration of a distributed coordination function inter-frame space (Distributed Coordination Function Inter-Frame Space, DIFS) needs to be waited for, and before an acknowledgment (acknowledgment, ACK) response is sent, duration of a short inter-frame space (Short Inter-Frame Space, SIFS) needs to be waited for. In addition, there are other inter-frame spaces (collectively referred to as xIFSs) in 802.11, for example, a point coordination function inter-frame space (Point Coordination Function Inter-Frame Space, PIFS). For example, the xIFSs may be classified based on different priorities of wireless medium access, and different priorities are classified based on duration of the xIFSs. Shorter duration of the xIFS indicates a higher corresponding priority. This is not specifically limited in this application.

A slot refers to a time segment or a time unit, that is, Slot Time or aSlotTime. In the CSMA/CA, a plurality of nodes contend for a channel. Before random access to the channel, a corresponding random backoff (backoff) process needs to be performed. The random backoff process includes a plurality of slots.

A contention window (Contention window, CW) is a range of a random backoff count value generated or selected by a node. A parameter of the contention window may be represented by CW, and the random backoff count value generated or selected by the node is randomly selected from an evenly distributed window [0, CW]. For example, if a parameter CW of a contention window of a node is 7, a range of the random backoff count value is [0, 7], and the random backoff count value determined by the node may be any value of 0, 1, 2, 3, 4, 5, 6, or 7.

In an implementation, a parameter CW of a contention window corresponding to a node is not a unique value or an unchanged value, and CW may include a plurality of values, for example, CW may include a plurality of values that increase exponentially. When a node initializes channel contention, a parameter of a contention window may be a minimum value of CW, that is, CWmin. If data retransmission needs to be performed each time a collision occurs when the node transmits data, the random backoff value successively increases until the maximum value of the CW, that is, CWmax, is reached. When the node successfully sends the data, CW may be reset to CWmin.

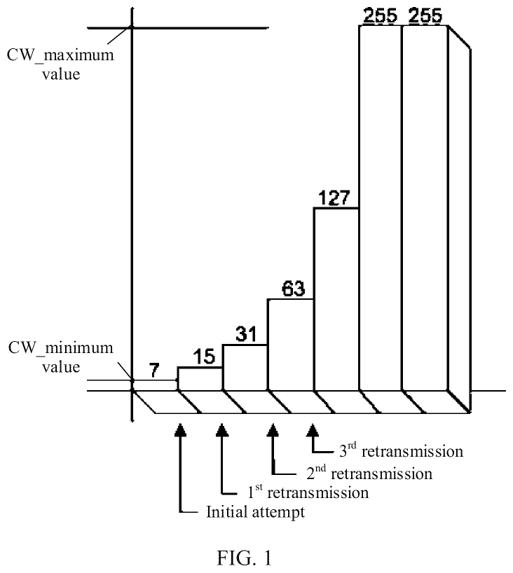

For example, as shown in FIG. 1, CWmin corresponding to a node is 7, and a contention window used when the node attempts to contend for a channel for an initial time is [0, 7]. If a first collision occurs, when 1^{st} retransmission is performed, the contention window is [0, 15]. When 2^{nd} retransmission is performed, the contention window is [0, 31]. When 3^{rd} retransmission is performed, the contention window is [0, 63]. The rest may be deduced by analogy. A parameter CW of each contention window may be obtained by subtracting 1 from a value obtained through 2 to a power of 2, and CWmax corresponding to the node may be 255.

Random backoff (Backoff, BO) refers to a process in which each node performs random backoff/waiting when contending for a channel. At the beginning of this process, the node first selects a random number from the contention window as an initial random backoff count value. Then, the node senses, in each slot, whether a current channel is idle. If the channel in the slot is idle, the random backoff count value is decreased for one time, that is, 1 is subtracted from the random backoff count value. If the channel in the slot is busy, the random backoff count value is not updated. When the random backoff count value of the node is updated to 0, it is considered that the node successfully obtains the channel through contention and may send data.

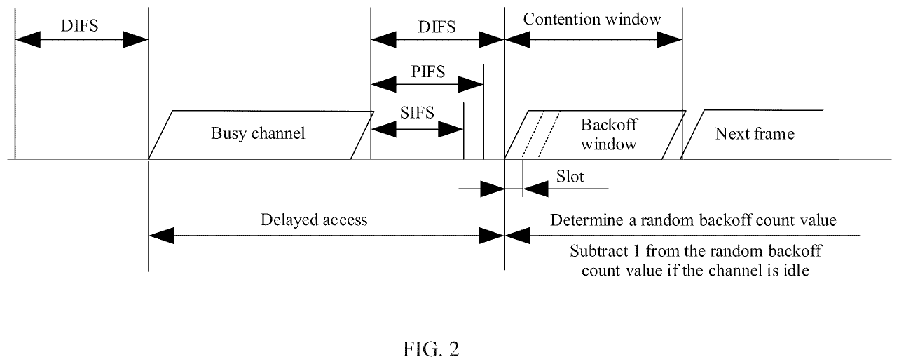

As shown in FIG. 2, before sending data, a STA first needs to wait for DIFS/PIFS/SIFS time. If a channel remains in the idle state in the DIFS/PIFS/SIFS time, the STA may perform the foregoing random backoff process. The STA selects a random backoff count value, and then performs channel sensing in a 1st slot. If the channel is idle, the STA subtracts 1 from the random backoff count value. If the random backoff count value is 0, the STA accesses the channel to send the data. If the random backoff count value is not 0, backoff continues to be performed, that is, channel sensing is performed in a next slot and the random backoff count value is updated, until it is detected that the channel is occupied.

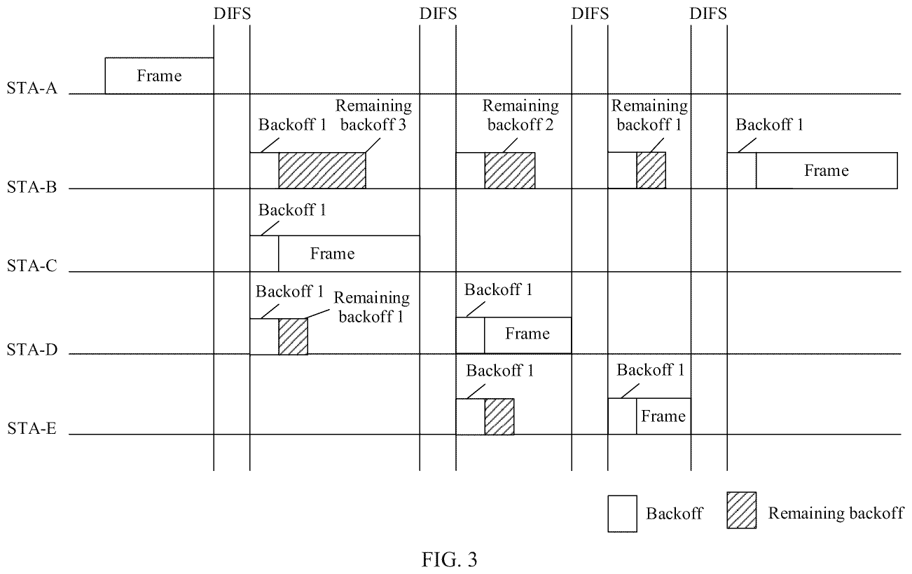

FIG. 3 is a diagram of a backoff mechanism between a plurality of STAs in the DCF manner. For example, a STA-A sends a data frame. A STA-B, a STA-C, and a STA-D contend for a channel at the same time, detect, in duration of waiting for a DIFS, that the current channel is idle, and separately generate a random backoff count value. For example, the random backoff count value generated by the STA-B is 4, the random backoff count value generated by the STA-C is 1, and the random backoff count value generated by the STA-D is 2. When the plurality of STAs contending for the channel detect, in a 1st backoff slot, that the channel is idle, 1 is subtracted from the random backoff count value. The random backoff count value of the STA-B is updated to 3, the random backoff count value of the STA-C is updated to 0, and the random backoff count value of the STA-D is updated to 1. In this case, the STA-C successfully occupies the channel to send a data frame. When another STA detects that the channel is idle again, waits for the duration of the DIFS, and detects that the channel is idle in a next backoff slot, 1 is subtracted from a random backoff count value. In this case, a station STA-E has a to-be-sent data frame, and a generated random backoff count value is 2. In this case, the STA-B, the STA-D, and the STA-E contend for the channel, and detect, in a slot, that the channel is idle. The random backoff count value of the STA-B is updated to 2, the random backoff count value of the STA-D is updated to 0, and the random backoff count value of the STA-E is updated to 1. In this case, the STA-D successfully occupies the channel to send a data frame. Correspondingly, the STA-E detects, in a next backoff slot, that the channel is idle. The random backoff count value is updated to 0, and the channel is successfully occupied to send the data frame. Finally, the STA-B detects, in a next backoff slot, that the channel is idle. The random backoff count value is updated to 0, and the channel is successfully occupied to send a data frame.

It can be learned from the foregoing backoff process that random backoff time for which the STA contending for the channel needs to perform backoff is the generated random backoff count value multiplied by duration of each slot (slot). For example, in the foregoing example in FIG. 3, the random backoff count value generated by the STA-B is 4, and the STA-B successfully accesses the channel after a 4th backoff slot. Therefore, random backoff time for which the STA-B needs to perform backoff=random number 4*duration of one slot (slot).

In addition, 802.11 introduces an enhanced distributed channel access (enhanced distributed channel access, EDCA) mechanism. To be specific, different fixed duration (collectively referred to as xIFSs), contention windows, and maximum allowable NAV duration values are designed for different services to meet priorities of different services.

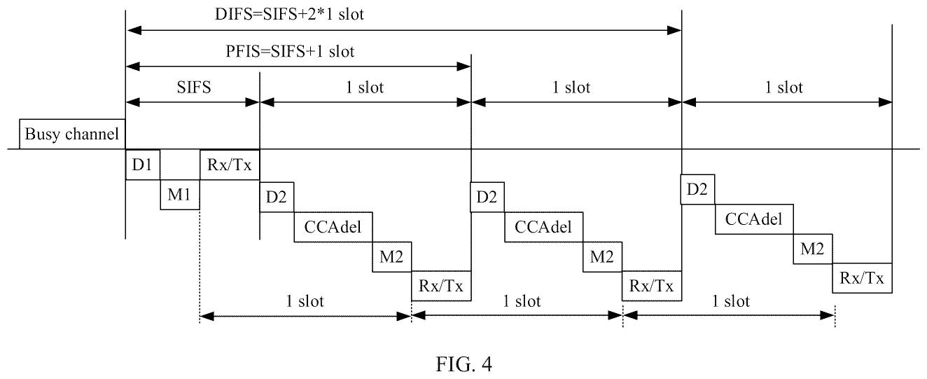

As shown in FIG. 4, a relationship between inter-frame spaces of different frames may be represented as PFIS=SIFS+aSlotTime, DIFS=SIFS+2*aSlotTime, and SIFS=D1+M1+Rx/Tx. D1 is a physical layer processing delay of a receiver, M1 is a MAC layer processing delay, Rx/Tx is transmit/receive transition duration, and aSlotTime indicates duration of one slot.

The duration aSlotTime of one slot includes four parts: D2, CCA detection duration (CCAdel), M2, and Rx/Tx. M2=M1 is the MAC layer processing delay, and D2 is a sum of D1 and air propagation time (aAirPropagationTime), that is, D2-D1+aAirPropagationTime. The CCA detection duration is represented by CCAdel, where CCAdel=CCA duration (aCCATime)−D1.

In other words, aSlotTime may be represented as aSlotTime=D2+CCAdel+M2+Rx/Tx.

aSlotTime may alternatively be represented as aSlotTime=aCCATime+aAirPropagationTime+M2+Rx/Tx.

It can be learned that in the backoff mechanisms shown in FIG. 2 and FIG. 3, the STA senses the channel in a part of the slot in a detection period of the slot, that is, senses the channel only in the CCA detection duration CCAdel. In addition, aSlotTime is greater than aCCATime.

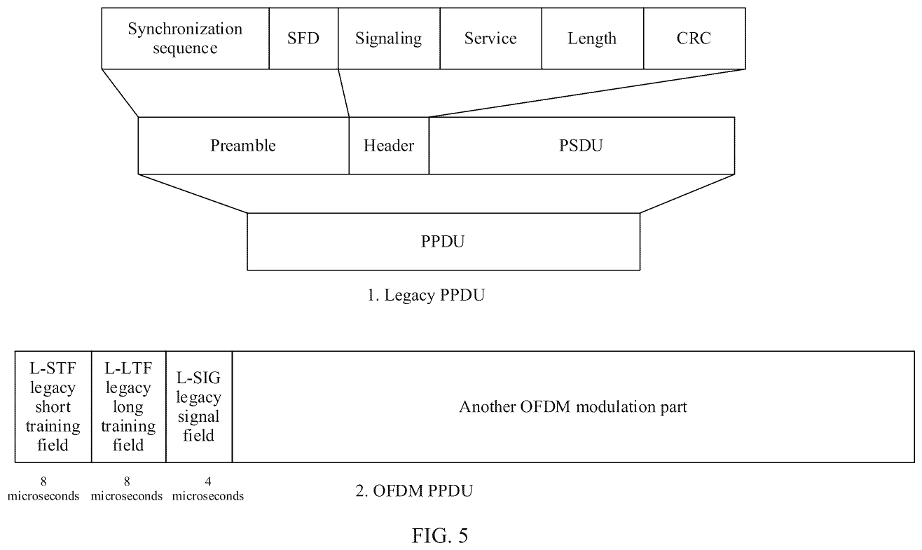

A physical frame of a WLAN network defined in the standard is referred to as a physical layer convergence protocol (physical layer convergence protocol, PLCP) data unit (PLCP data unit, PPDU). FIG. 5 shows a legacy PPDU format. The PPDU includes a preamble, a header (header), and a PLCP service data unit (PLCP service data unit, PSDU). Usually, the PSDU includes a data payload (payload). The preamble includes a synchronization (synchronization, SYNC) sequence and a start of frame delimiter (start of frame delimiter, SFD). The header includes physical parameters related to data transmission, for example, signaling (signaling), a service (service), a length (length) of to-be-transmitted data, and a 16-bit cyclic redundancy check (Cyclic Redundancy Check, CRC) code. For detailed descriptions, refer to related technical descriptions of the PPDU. Details are not described in this application.

Since the 802.11g standard, a PPDU based on an orthogonal frequency division multiplexing (Orthogonal Frequency Division Multiplexing, OFDM) technology is defined. FIG. 5 shows an OFDM PPDU format. The PPDU includes a legacy short training field (Legacy Short Training Field, L-STF), a legacy long training field (Legacy Long Training Field, L-LTF), a legacy signal field (Legacy Signal Field, L-SIG), and another OFDM modulation part.

The L-STF is also referred to as a non-high throughput short training field, includes 10 periods of 0.8 microseconds, that is, 8 microseconds in total, and is used by a receive end to perform PPDU detection, automatic gain control, coarse time synchronization, and coarse frequency synchronization.

The L-LTF is also referred to as a non-high throughput long training field, includes one guard interval of 1.6 microseconds and two repeated long training sequence parts of 3.2 microseconds, and is used by the receive end to perform channel estimation, precise time synchronization, and precise frequency synchronization.

The L-SIG is also referred to as a non-high throughput signaling field, includes a guard interval of 0.8 microseconds and a signaling part of 3.2 microseconds, and carries signaling information used to demodulate a subsequent data part. A length field and a rate field in the L-SIG field are used for duration of a remaining part after the L-SIG field.

It can be learned from the foregoing content that aCCATime is less than aSlotTime, that is, a part of time included in one slot is used for channel detection. However, as defined in the current standard, in a 2.4 GHz frequency band, aSlotTime is 9 microseconds, aSIFSTime is 10 microseconds, and aCCATime is implemented based on a device and is less than 9 microseconds. In a 5 GHz or 6 GHz frequency band, aSlotTime is 9 microseconds, aSIFSTime is 16 microseconds, and aCCATime is implemented based on a device and is less than 9 microseconds.

In a case of a longer range, to detect a signal, the receive end needs to perform a cross-correlation or autocorrelation operation based on a signal of longer time, to identify presence of the signal. For example, a WLAN device needs to identify a signal via four 0.8-microsecond periods (3.2 microseconds in total) in 8 microseconds of an L-STF, where aCCATime is 3.2 microseconds. For a long range transmission device, it may take longer time to identify a signal. For example, aCCATime is an integer multiple of 8 microseconds, 12 microseconds, or 3.2 microseconds. Existing aSlotTime (9 microseconds) is not enough for the long range transmission device to detect whether there is a signal sent to the long range transmission device. If the long range device still detects whether a channel is idle or busy via existing aSlotTime (9 microseconds), a signal sent by another device to the long range device may be missed, and consequently data receiving may be missed. In addition, further, if the long range device does not detect that the channel is busy and sends a signal, collision of a plurality of signals may be further caused, interference is generated, and an overall throughput of a system is affected.

Therefore, in a next-generation standard, a new PPDU type may be defined for long range transmission. Correspondingly, CCA detection time required by the new PPDU type may be longer, that is, aSlotTime is also longer. In this case, a success rate of contending for a channel by a node by using the foregoing random backoff mechanism is significantly reduced. How to improve a probability of accessing the channel by this type of device is a problem to be resolved in this application.

Based on the foregoing problem, this application provides a channel access method. Backoff duration of a random backoff mechanism and a decreasing algorithm of a random backoff count value are improved in a process in which a node contends for a channel, so that a success rate of contending for a channel by a long range transmission device is improved, and the device can access the channel more fairly. This improves communication efficiency of long range transmission.

In addition, a trigger-based and scheduling-based uplink transmission method is further defined in the current standard. During trigger-based multi-user uplink transmission, an AP may allocate, to one or more STAs via a trigger frame (trigger frame), a resource unit (resource unit, RU) used for uplink transmission. This is also referred to as that the AP may schedule the resource unit for the one or more STAs via the trigger frame.

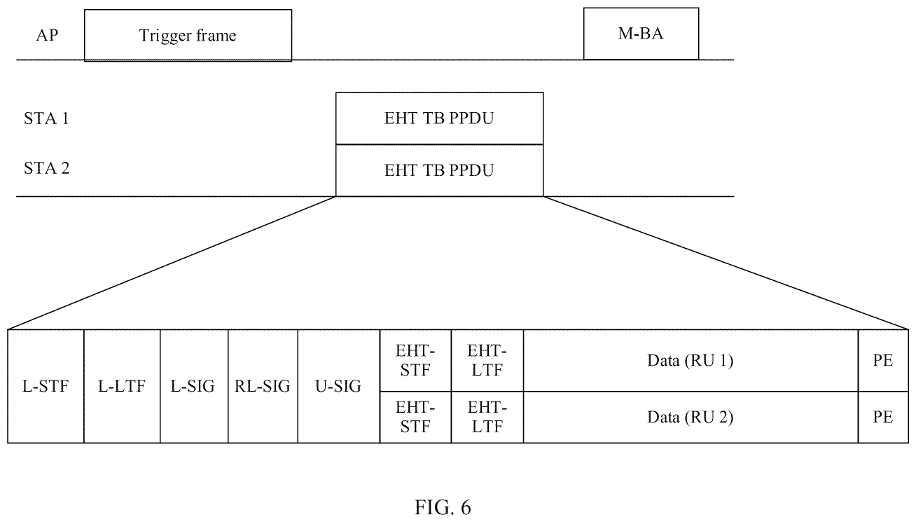

Specifically, as shown in FIG. 6, a process in which the AP schedules the resource unit for the one or more STAs via the trigger frame may include the following steps.

Step 1: The AP sends the trigger frame, where the trigger frame includes a resource scheduling parameter and another parameter that are used by the one or more STAs to send uplink data. The AP needs to contend for a channel to obtain an opportunity to transmit the trigger frame. For a frame structure of the trigger frame, refer to a related technology. Details are not described in this application.

Step 2: The STA receives the trigger frame, obtains, through parsing from the trigger frame, a user information field that matches an association identifier of the local station, and then sends an extremely high throughput trigger-based data packet (Extremely High Throughput Trigger-Based Physical layer Protocol Data Unit, EHT TB PPDU) on a resource unit indicated by a resource unit allocation subfield in the user information field. Names and simple functions of fields of the PPDU are shown in the following:

TABLE 1
Meanings of fields in an EHT TB PPDU

| Abbre- | English | | |
|---|---|---|---|
| viation | expression | Chinese name | Function |
| L-STF | Legacy short | Legacy short | Used for PPDU |
| | training field | training field | discovery, coarse |
| | | | synchronization, |
| | | | and automatic |
| | | | gain control |
| L-LTF | Legacy long | Legacy long | Used for precise |
| | training field | training field | synchronization |
| | | | and channel estimation |
| L-SIG | Legacy signal | Legacy signal | Used for carrying |
| | field | field | signaling |
| | | | information related |
| | | | to a PPDU |
| | | | length, to ensure |
| | | | coexistence |
| RL-SIG | Repeated | Repeated | Used for carrying |
| | legacy | legacy | signaling |
| | signal field | signal field | information related |
| | | | to a PPDU |
| | | | length, to ensure |
| | | | coexistence |
| U-SIG | Universal SIG | Universal | Used for carrying |
| | | signaling | related signal |
| | | field | information |
| | | | like a PPDU |
| | | | bandwidth and a |
| | | | basic service set |
| | | | color |
| EHT-STF | Extremely | Extremely | Used for automatic |
| | high- | high- | gain control of |
| | throughput | throughput | a subsequent field |
| | short | short | |
| | training field | training field | |
| EHT-LTF | Extremely high- | Extremely high- | Used for channel |
| | throughput long | throughput long | estimation |
| | training field | training field | |
| Data | Data | Data | Used for carrying |
| | | | data information |
| PE | Packet | Packet | Used for increasing |
| | extension | extension | processing time |
| | | | of a receiver |

Optionally, as shown in FIG. 6, a STA 1 and a STA 2 simultaneously send EHT TB PPDUs to the AP.

Step 3: Optionally, the AP receives the EHT TB PPDU sent by the STA, and sends an acknowledgment frame to the STA.

The AP successfully obtains data from the EHT TB PPDU through parsing, and sends the acknowledgment frame to the STA.

The foregoing trigger-based transmission enables the STA to send the uplink data by using a transmission opportunity of the AP when the AP obtains the channel. However, this is not applicable to channel contention and data receiving and sending during the long range transmission. In addition, the existing trigger frame has high overheads, and is not suitable for the long range transmission at a low transmission rate.

Based on the foregoing problem, this application provides a channel access method. Long range PPDU transmission including trigger information is performed to provide a trigger frame with low overheads, reduce signaling overheads of the long range transmission, and improve the communication efficiency of the long range transmission without affecting the existing random backoff mechanism in which the AP contends for the channel.

Then, an implementation environment and an application scenario of embodiments of this application are briefly described.

This application provides a WLAN communication system to which an embodiment of this application is applicable. The WLAN communication system includes at least one wireless access point AP and/or at least one station. It should be noted that a STA in embodiments of this application may also be referred to as a terminal, and the STA and the terminal may be mutually replaced. This is not specifically limited in the method provided in this application.

In an example, FIG. 7 is a diagram of an architecture of the WLAN communication system according to this application. In FIG. 7, the WLAN communication system includes at least one AP, for example, an AP 1 and an AP 2. For example, the AP 1 may be associated with a STA 1, a STA 2, and a STA 3. The AP 1 may schedule a radio resource for a STA associated with the AP 1 and/or a STA not associated with the AP 1, and transmit data for the STA on the scheduled radio resource. For example, the AP 1 may schedule a radio resource for the STA 1, the STA 2, the STA 3, and the like, and transmit data, including uplink data information and/or downlink data information, for the STA 1, the STA 2, and the STA 3 on the scheduled radio resource.

In addition, embodiments of this application can be applicable to data communication between one or more APs and one or more STAs, and are also applicable to communication between APs and communication between STAs.

The STA in embodiments of this application may be a wireless communication chip, a wireless sensor, or a wireless communication terminal, for example, a user terminal, a user apparatus, an access apparatus, a subscriber station, a subscriber unit, a mobile station, a user agent, and user equipment that support a Wi-Fi communication function. The user terminal may include various handheld devices, vehicle-mounted devices, wearable devices, Internet of things (internet of things, IoT) devices, or computing devices that have a wireless communication function, or another processing device connected to a wireless modem, user equipments (user equipment, UE) of various forms, a mobile station (mobile station, MS), a terminal (terminal), a terminal device (terminal device), a portable communication device, a handheld device, a portable computing device, an entertainment device, a game device or system, a global positioning system device, or any other appropriate device configured to perform network communication via a wireless medium. In addition, the STA may support the 802.11be standard. The STA may also support a plurality of WLAN standards such as 802.11ax, 802.11ac, 802.11n, 802.11g, 802.11b, 802.11a, or a future standard of the 802.11be standard.

The AP in embodiments of this application may be an apparatus that is deployed in a wireless communication network to provide a wireless communication function for a STA associated with the AP. The AP is mainly deployed at home, inside a building, and in a campus, with a typical coverage radius of tens of meters to hundreds of meters. Certainly, the AP may alternatively be deployed outdoors. The AP is equivalent to a bridge that connects a wired network and a wireless network. The AP is mainly used to connect wireless network clients to each other, and then connect the wireless network to the Ethernet. Specifically, the AP may be a communication device with a Wi-Fi chip, for example, a base station, a router, a gateway, a repeater, a communication server, a switch, or a bridge. The base station may include macro base stations, micro base stations, relay stations, and the like in various forms. In addition, the AP may support the 802.11be standard. The AP may also support WLAN standards such as 802.11ax, 802.11ac, 802.11n, 802.11g, 802.11b, 802.11a, or a next generation of the 802.11be standard. This is not limited in this application.

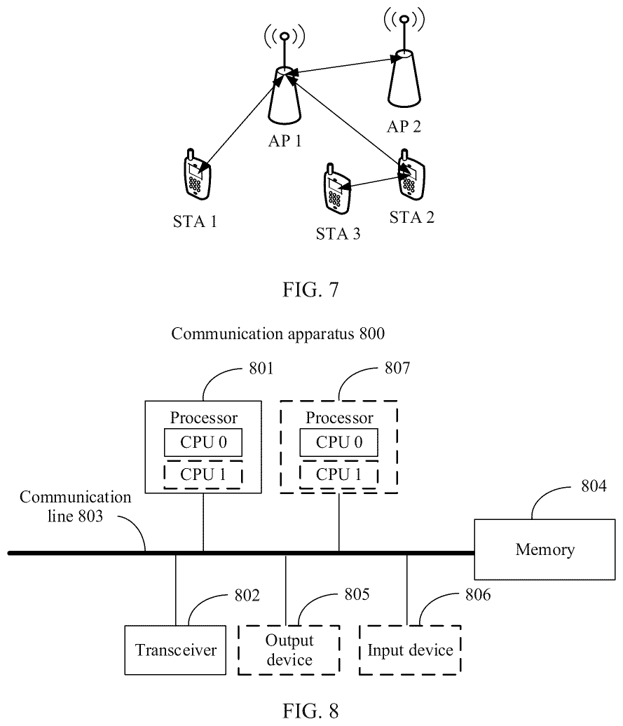

In some embodiments, the AP and the STA in this application may be collectively referred to as a WLAN device. During specific implementation, the WLAN device may use a structure shown in FIG. 8, or include components shown in FIG. 8.

FIG. 8 is a composition diagram of a communication apparatus 800 according to an embodiment of this application. The communication apparatus 800 may be specifically a WLAN device, and may be a STA or a chip or a chip system (or referred to as a system on chip) in a STA, or may be an AP or a chip or a chip system (or referred to as a system on chip) in an AP. In embodiments of this application, the chip system may include a chip, or may include a chip and another discrete component.

As shown in FIG. 8, the communication apparatus 800 includes a processor 801, a transceiver 802, and a communication line 803. Further, the communication apparatus 800 may include a memory 804. The processor 801, the memory 804, and the transceiver 802 may be connected through the communication line 803.

The processor 801 is a central processing unit (central processing unit, CPU), a general-purpose processor, a network processor (network processor, NP), a digital signal processor (digital signal processor, DSP), a microprocessor, a microcontroller, a programmable logic device (programmable logic device, PLD), or any combination thereof. Alternatively, the processor 801 may be another apparatus having a processing function, for example, a circuit, a component, or a software module. This is not limited.

The transceiver 802 is configured to communicate with another device or another communication network. The another communication network may be the Ethernet, a radio access network (radio access network, RAN), a WLAN, or the like. The transceiver 802 may be a module, a circuit, a transceiver, or any apparatus that can implement communication.

The communication line 803 is configured to transmit information between components included in the communication apparatus 800.

The memory 804 is configured to store instructions. The instructions may be a computer program.

The memory 804 may be a read-only memory (read-only memory, ROM) or another type of static storage device that can store static information and/or instructions, or may be a random access memory (random access memory, RAM) or another type of dynamic storage device that can store information and/or instructions, or may be an electrically erasable programmable read-only memory (electrically erasable programmable read-only memory, EEPROM), a compact disc read-only memory (compact disc read-only memory, CD-ROM) or another compact disc storage, optical disc storages (including a compressed optical disc, a laser disc, an optical disc, a digital universal optical disc, a Blu-ray optical disc, and the like), a magnetic disk storage medium or another magnetic storage device, or the like. This is not limited.

It should be noted that the memory 804 may exist independently of the processor 801, or may be integrated with the processor 801. The memory 804 may be configured to store instructions, program code, some data, or the like. The memory 804 may be located inside the communication apparatus 800, or may be located outside the communication apparatus 800. This is not limited. The processor 801 is configured to execute the instructions stored in the memory 804, to implement the method provided in the following embodiments of this application.

In an example, the processor 801 may include one or more CPUs, for example, a CPU 0 and a CPU 1 in FIG. 8.

In an optional implementation, the communication apparatus 800 includes a plurality of processors. For example, the communication apparatus 800 may further include a processor 807 in addition to the processor 801 in FIG. 8.

In an optional implementation, the communication apparatus 800 further includes an output device 805 and an input device 806. For example, the input device 806 is a device like a keyboard, a mouse, a microphone, or a joystick, and the output device 805 is a device like a display or a speaker (speaker).

It should be understood that the composition structure shown in FIG. 8 does not constitute a limitation on the WLAN device. In addition to the components shown in FIG. 8, the WLAN device may include more or fewer components than those shown in the figure, or combine some components, or have different component arrangements.

With reference to the accompanying drawings, the following describes the technical solutions provided in embodiments of this application.

It should be noted that a length of each field in this application is merely an example for description. That the length of each field needs to be the length provided in this application, and the length of each field may be longer or shorter than the length provided in this application is not limited in this application.

It should be noted that, in the following embodiments of this application, a name of a message between the apparatuses, a name of each parameter, a name of each piece of information, or the like is merely an example, and may be another name in another embodiment. This is not specifically limited in the method provided in this application.

It may be understood that, in embodiments of this application, the AP and/or the STA may perform some or all of the steps in embodiments of this application. These steps or operations are merely examples. In embodiments of this application, other operations or variations of various operations may be further performed. In addition, the steps may be performed in a sequence different from a sequence presented in embodiments of this application, and not all operations in embodiments of this application need to be performed.

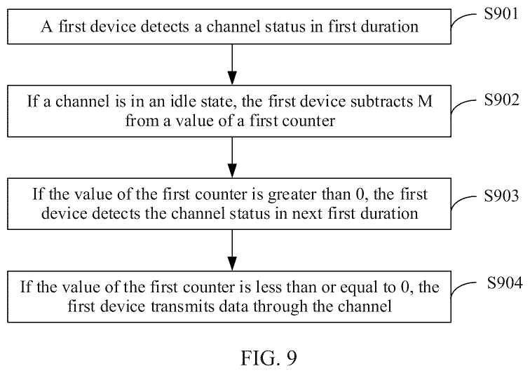

As shown in FIG. 9, this application provides a channel access method, applied to a first device. The first device may be an AP or a STA, and the first device may be a node that performs long range transmission. The method includes the following steps.

S901: The first device detects a channel status in first duration.

The first duration indicates sensing duration of a channel detection window of the first device.

In an implementation, the first duration is greater than duration of one first time unit. For example, the first time unit may be one slot. For example, in the foregoing existing solution, a first time unit (namely, aSlotTime) corresponding to the 2.4 GHz frequency band may be 9 microseconds. In this case, in this embodiment of this application, a channel detection window corresponding to a long range transmission device may be 27 microseconds, that is, the first duration may be 27 microseconds. In other words, for the long range transmission device, sensing duration of a channel detection window in a random backoff mechanism is longer than sensing duration of a common device.

In addition, when enabling the random backoff mechanism to contend for a channel, the first device may generate or select a random backoff count value based on the foregoing contention window. For example, the first device may randomly generate the random backoff count value in a contention window [0, CW]. In this embodiment of this application, the random backoff count value may be implemented by using a first counter. Therefore, a value of the first counter represents the random backoff count value, and the value of the first counter is updated to represent decreasing or backoff of the random backoff count value. Details are not described below again.

In an implementation, before step S901, that is, before the first device detects the channel status in the first duration, the first device waits for a first inter-frame gap, and the first device detects, in the first inter-frame gap, that the channel is in an idle state, to enable the random backoff mechanism to contend for the channel.

For example, the first inter-frame gap may be a point coordination function inter-frame space of long range (PIFS of long range, PIFSLR), a short inter-frame space SIFS, a distributed coordination function inter-frame space of long range (DIFS of long range, DIFSLR), or the like. In addition, there may be another type of frame and a corresponding inter-frame gap. This is not limited in this application.

For duration of the first inter-frame gap, a fixed length defined in the existing standard may be maintained. Alternatively, an inter-frame space may be updated based on aSlotTimeLR in this application, that is, duration of a part of the inter-frame space is correspondingly increased.

It can be learned from the foregoing that short inter-frame space SIFS=D1+M1+Rx/Tx, that is, duration of the SIFS is implemented based on a device.

In an implementation, a length defined in the existing standard may be maintained for duration of the PIFSLR or duration of the DIFSLR, that is, PIFSLR=PIFS=SIFS+aSlotTime, and DIFSLR=DIFS=SIFS+2*aSlotTime.

In another implementation, a corresponding fixed inter-frame space may be correspondingly increased based on first duration of a random detection window. For example, if the first duration is aSlotTimeLR, the PIFSLR is a sum of the SIFS and the first duration, that is, PIFSLR-SIFS+aSlotTimeLR.

The DIFSLR is a sum of the SIFS and twice the first duration, that is, DIFSLR-SIFS+2*aSlotTimeLR.

In the foregoing implementation, for a long range communication scenario, the corresponding fixed inter-frame space is correspondingly increased based on the first duration of the random detection window. This helps a long range communication device to more accurately identify, during initial detection after a channel is busy, whether a signal exists on an air interface.

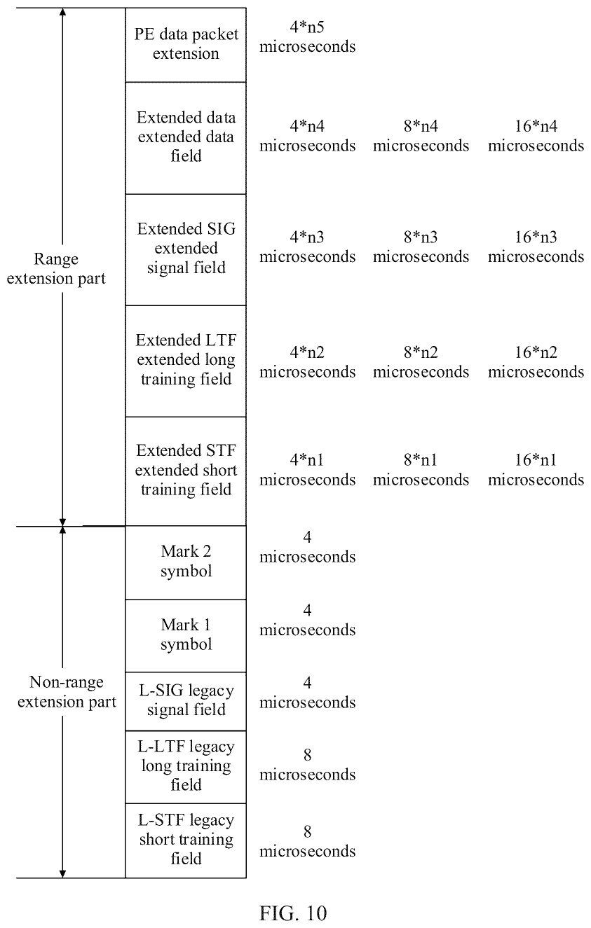

In an implementation, this application provides a PPDU format for range extension, also referred to as a long range PPDU. As shown in FIG. 10, the PPDU includes two parts. A first part is a non-range extension part, and is used to ensure signaling compatibility with a legacy non-long range transmission device. A second part is a range extension part, and is used for mutual communication between long range transmission devices.

As shown in FIG. 10, the non-range extension part includes an L-STF, an L-LTF, an L-SIG, a mark 1 symbol, and a mark 2 symbol. For content of the L-STF, the L-LTF, and the L-SIG field, refer to related descriptions of the foregoing PPDU format. Details are not described herein again. The mark 1 symbol and/or the mark 2 symbol are/is used by a receive end to identify whether the PPDU is the long range PPDU.

In an implementation, the mark 1 symbol may be referred to as an ER BPSK mark 1, and the mark 2 symbol may be referred to as an ER BPSK mark 2. Implementation methods of the ER BPSK mark 1 and/or the ER BPSK mark 2 may include the following two types:

Method 1: The ER BPSK mark 2 is the same as the L-SIG field.

Therefore, the receive end may identify, by determining that the L-SIG field is the same as a 2^{nd} symbol following the L-SIG field, that the PPDU is a PPDU used for the range extension.

Method 2: The ER BPSK mark 1 and/or the ER BPSK mark 2 are obtained by multiplying different data subcarriers of the L-SIG field by a mixed sequence including +1 and −1.

For example, the ER BPSK mark 1 is obtained by multiplying the data subcarriers of the L-SIG field by the sequence of +1 and −1 at sequential spacings. After receiving a PPDU, the receive end separately multiplies a 1st symbol following the L-SIG field by a sequence of all −1s, multiplies the 1st symbol following the L-SIG field by the mixed sequence of +1 and −1, and then determines whether results are the same as the L-SIG field (or determines a probability that the results are the same as the L-SIG field), to determine whether the PPDU is the long range PPDU.

A BPSK mark 1 and a BPSK mark 2 of a wake-up radio (wake-up radio, WUR) PPDU are multiplied by the sequence of all −1s. Therefore, the receive end may multiply a 1^{st} symbol and/or a 2^{nd} symbol following the L-SIG field by a corresponding sequence, and determine whether a result is the same as the L-SIG field (or determine a probability that the result is the same as the L-SIG field), to identify the PPDU. For example, if a probability that a result obtained by multiplying the 1^{st} symbol and/or the 2nd symbol following the L-SIG field by all −1s is the same as the L-SIG field is higher, the PPDU is the WUR PPDU, and if a probability that a result obtained by multiplying the 1st symbol and/or the 2nd symbol following the L-SIG field by the mixed sequence of +1 and −1 is the same as the L-SIG field is higher, the PPDU is the PPDU used for range extension. In addition, for an HE (High Efficiency, high efficiency) PPDU and an EHT (Extremely High-Throughput, extremely high-throughput) PPDU, 1st symbols following L-SIG fields of the HE PPDU and the EHT PPDU are the same as the L-SIG fields. Therefore, it may be considered that the 1^{st} symbols following the L-SIG fields of the HE PPDU and the EHT PPDU are multiplied by a sequence of all 1s In this application, Method 2 may also be used to distinguish between the two types of PPDUs and the long range PPDU.

In addition, the range extension part includes an extended STF, an extended LTF, an extended SIG field, an extended data field, and a PE data packet extension field.

After a legacy field like the L-STF, the L-LTF, or the L-SIG field is transmitted for an enough long range, the receive end performs energy accumulation based on a detected received signal. Due to signal attenuation in the long range transmission, the received signal may be below sensitivity of the receive end, and may be considered as noise by the receive end. Consequently, the receive end cannot correctly identify a PPDU sent to the receive end. Therefore, embodiments of this application provide an enhanced signaling field and a data field that are used by the receive end to correctly demodulate corresponding information. The extended STF, namely, an extended short training field, is used by the receive end to identify a signal with a lower signal-to-noise ratio. The extended LTF, namely, an extended long training field, is used to improve accuracy of channel estimation. For example, as shown in FIG. 10, the extended STF may include four n1 microseconds, may include eight n1 microseconds, may include 16 n1 microseconds, or the like. The extended field may be considered as weighted repetition of a signal in time domain.

In an implementation, because the Barker (Barker) code has a good correlation feature, and can help the receive end accurately detect the PPDU, a sequence like the Barker code may be used to extend a symbol of an existing field like an STF modulated through OFDM, to obtain the foregoing extended field.

For example, the receive end may perform cross-correlation or autocorrelation for a signal of longer time based on the extended STF field, to identify presence of the signal, improve an equivalent signal-to-noise ratio, and detect a PPDU in a longer range. In addition, extension is performed on a basis of an OFDM symbol, so that an advantage and an existing design of OFDM modulation can be maintained. For example, the OFDM modulation helps resist frequency-selective fading, and solutions such as coding, interleaving, and frequency domain repetition based on the OFDM modulation can still be maintained.

In an implementation, in a random backoff process, duration of each channel detection window corresponding to a long range transmission node may be denoted as aSlotTimeLR, and aSlotTimeLR is greater than aSlotTime in the conventional technology. If the random backoff count value generated by the first device is greater than 0, the long range transmission device detects the channel status based on longer CCA duration CCATimeLR and longer random backoff duration aSlotTimeLR.

Optionally, the first duration is a part or all of aSlotTimeLR. For example, the first duration may be aSlotTimeLR, the first duration is the CCA duration like CCATimeLR, or the first duration may be CCA detection duration like CCAdel, where CCA detection duration (CCAdel LR)<CCATimeLR<aSlotTimeLR.

For example, aSlotTimeLR may be 27 microseconds.

S902: If the channel is in the idle state, the first device subtracts M from the value of the first counter.

M is a positive integer greater than 1. The first counter may be a counter corresponding to the random backoff count value in a process in which the first device performs random backoff to contend for the channel.

When finding, in aSlotTimeLR, that the channel is idle, the first device subtracts M from the backoff counter, where M is the positive integer greater than 1.

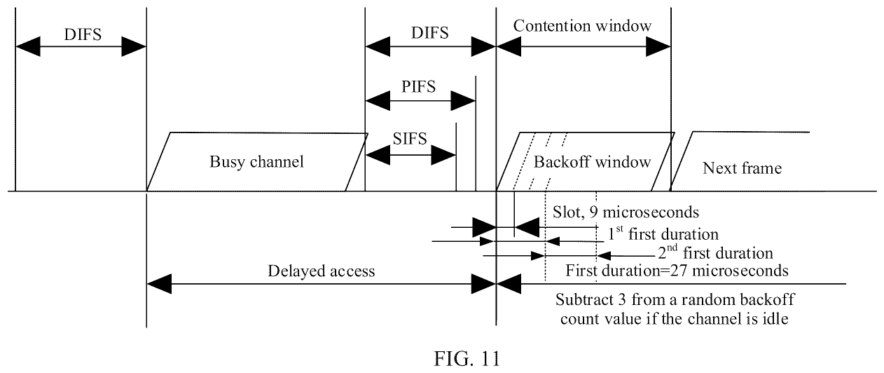

For example, as shown in FIG. 11, M may be 3, aSlotTimeLR is 27 microseconds, aSlotTime is 9 microseconds, and aSlotTimeLR is three times aSlotTime. When finding that the channel is idle in duration of aSlotTimeLR, the first device subtracts 3 from the random backoff count value, in other words, the first device subtracts 3 from the first counter. It should be noted that aSlotTimeLR may be an integer multiple of aSlotTime, or may not be an integer multiple of aSlotTime. In FIG. 11, M-aSlotTimeLR/aSlotTime is merely an example. M may be a positive integer greater than 1, for example, 2, 3, 4, or 5. A larger value of M indicates that the random backoff count value of the first device is back off to 0 more quickly, and therefore, a success rate of contending for the channel by the first device is higher. Values of aSlotTimeLR and M are not limited in embodiments of this application.

S903: If the value of the first counter is greater than 0, the first device detects the channel status in next first duration.

Specifically, if the first device determines that the value of the first counter is greater than 0, the first device detects the channel status in the next first duration after an end moment of the first duration. In other words, after a 1st channel detection window of the first duration of the first device ends, the first device opens a 2nd channel detection window of the first duration to perform sensing, to detect whether the current channel is in the idle state. If a channel detection result of the 2nd channel detection window of the first duration is that the channel is idle, the value of the first counter is updated, that is, M is subtracted from the value of the first counter for another time. If a channel detection result of the 2nd channel detection window of the first duration is that the channel is busy, the value of the first counter is not updated.

As shown in FIG. 11, the first device detects the channel status in 2nd first duration, and if determining that the channel is idle, subtracts M from the value of the first counter for another time, to update the value of the first counter.

Subsequently, the first device further determines whether the value of the first counter is greater than 0. If the value of the first counter is greater than 0, the first device opens a 3^{rd} channel detection window of the first duration to perform sensing. The rest may be deduced by analogy.

S904: If the value of the first counter is less than or equal to 0, the first device transmits data through the channel.

If the first device determines that the current value of the first counter is less than or equal to 0, it is considered that the first device successfully contends for the channel, and the first device may access the channel to transmit the data.

In an implementation, the first device may send a long range physical layer protocol data unit PPDU through the channel.

In the foregoing implementation, when performing random channel contention, the long range transmission node increases a backoff value of the counter each time in the random backoff process, so that the counter can be back off to 0 or a value less than 0 more quickly, thereby accelerating a backoff speed of the long range transmission node and ensuring fairness of random channel contention, and improving transmission efficiency of a long range device.

In addition, it can be learned from the foregoing CCA detection mechanism that when determining that strength of the currently detected channel is less than a CCA detection threshold, the first device considers that the current channel detection result is that the channel is busy. When determining that strength of the currently detected channel is greater than or equal to a CCA detection threshold, the first device considers that the current channel detection result is that the channel is busy.

Therefore, in addition to the foregoing improvement solution of the fast backoff of the counter, the CCA detection threshold corresponding to the long range transmission device may be further increased, so that the long range device is more likely to consider that the air interface is in the idle state, thereby increasing a transmission probability of the long range device.

In another implementation, a CW value corresponding to the long range transmission device may be decreased, that is, a range of the random backoff count value generated or selected by the long range transmission node is decreased, so that the long range transmission device is more likely to generate a small random backoff count value. Therefore, in the random backoff process, it is easier to be back off to 0 (or be back off to a value less than 0), to improve a success rate of contending for the channel by the long range device, and improve the transmission efficiency.

For example, CWmin in the foregoing example is 7. For the long range device, when the random backoff count value is generated for an initial time, CW may be set to 5. In this case, the range of the random backoff count value generated by the long range device is [0, 5].

Further optionally, if the transmission of the long range device fails, when the random backoff count value is generated for another time, a backoff window may not be doubled based on a power of 2, or may be doubled based on a power smaller than 2. Alternatively, the backoff window is not doubled. In this way, the success rate of contending for the channel for transmission by the long range device is improved. For example, in the foregoing example, for the common device, a contention window during initial transmission is [0, 7], and a contention window during 1st retransmission is [0, 15]. For the long range device, a contention window during initial transmission may be [0, 5], and a contention window during 1st retransmission may be [0, 10].

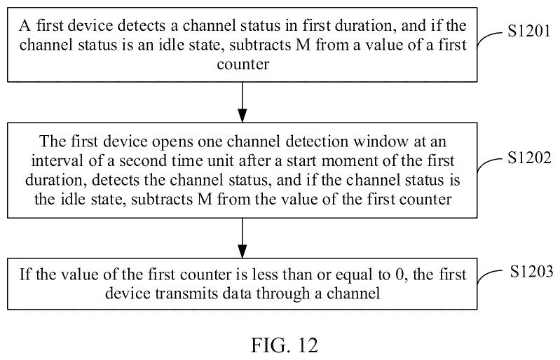

In addition, this application further provides a channel access method, to implement a backoff mechanism of parallel CCA detection by using a sliding window. The method may be applied to a first device. The first device may be an AP or a STA, and the first device may be a node that performs long range transmission. As shown in FIG. 12, the method includes the following steps.

S1201: The first device detects a channel status in first duration, and if the channel status is an idle state, subtracts M from a value of a first counter.

In an implementation, the first duration is a part or all of duration of aSlotTimeLR.

In an implementation, the first duration may be greater than duration of one first time unit. For example, the first time unit may be one slot, and duration of the slot is 9 microseconds. For example, aSlotTimeLR may be 27 microseconds.

The first duration indicates sensing duration of a 1st channel detection window opened by the first device. In other words, for a long range transmission device, sensing duration of a channel detection window in a random backoff mechanism is longer than sensing duration of a common device.

In addition, when enabling the random backoff mechanism to contend for a channel, the first device may generate or select a random backoff count value based on the foregoing contention window. For example, the first device generates the first counter, and may generate a random value in a contention window [0, CW] as the value of the first counter.

If a channel detection result of the first device in the first duration is the idle state, the first device subtracts M from the value of the first counter. M is a positive integer, for example, M may be 1. Alternatively, M may be a positive integer greater than 1, to accelerate backoff.

In a possible implementation, if an initial value of the first counter of the first device is 0, step S1203 may be directly performed. In other words, the first device may access the channel, and transmit data through the channel.

It should be noted that the channel state being the idle state in step S1201 is specifically a result obtained by the first device by performing clear channel assessment in the first duration. For a specific process, refer to the description of the foregoing related technology. Details are not described herein again.

S1202: The first device opens one channel detection window at an interval of a second time unit after a start moment of the first duration, detects the channel status, and if the channel status is the idle state, subtracts M from the value of the first counter.

In other words, the first device may open one channel detection window each time the first device slides one second time unit, that is, there is an interval of a second time unit between start moments of channel detection windows, so that the first device may open a plurality of channel detection windows at the same time to detect channel statuses in parallel.

It should be noted that a time sequence relationship between steps S1201 and S1202 is not limited in this embodiment of this application. After starting to detect the channel status in the first duration, the first device opens one channel detection window at the interval of the second time unit. However, the result of the channel status detection in the first duration may be obtained only after the first duration ends. Therefore, an execution time sequence of updating the value of the first counter by the first device is not specifically limited in this embodiment of this application.

In an implementation, duration of the plurality of channel detection windows that are opened in parallel may be the same or may be different. The channel detection window may be of preset duration, and the duration of the channel detection window may be greater than or less than the first duration.

In an implementation, the duration of the channel detection window may be the first duration. In other words, the duration of the plurality of channel detection windows that are opened in parallel by the first device at the interval of the second time unit may be the first duration. This is equivalent to that the first device opens the plurality of channel detection windows of the first duration at the same time to sense to the channel statuses, so that frequency of channel detection performed by the long range device can be increased.

Sliding duration (sliding step) of the channel detection window is one second time unit. In an implementation, the second time unit may be one slot, that is, aSlotTime. Alternatively, the second time unit may be preconfigured fixed duration. For example, the time unit is set to 4 microseconds or 3 microseconds.

If the channel status corresponding to the first device in any channel detection window is the idle state, M is subtracted from the value of the first counter each time. That the channel state being the idle state in step S1202 is specifically a result obtained by the first device by performing clear channel assessment in the any channel detection window. For a specific process, refer to the description of the foregoing related technology. Details are not described herein again.

In other words, if a channel detection result obtained in one channel detection window is that the channel is idle, and the value of the first counter is greater than 0, the first device subtracts M from the first counter for one time.

For example, the first device performs channel detection in one channel detection window. If a channel status obtained in the channel detection window is the idle state, the first device may subtract M from the value of the first counter for one time. If a channel status obtained in a next channel detection window is still the idle state, the first device subtracts M from the value of the first counter for another time. The rest may be deduced by analogy. If the current first device successively opens N channel detection windows in total, and channel statuses obtained by the N channel detection windows are all idle states, the value of the first counter is decreased by M*N accumulatively. In this way, effect of the fast backoff of the random count value is achieved.

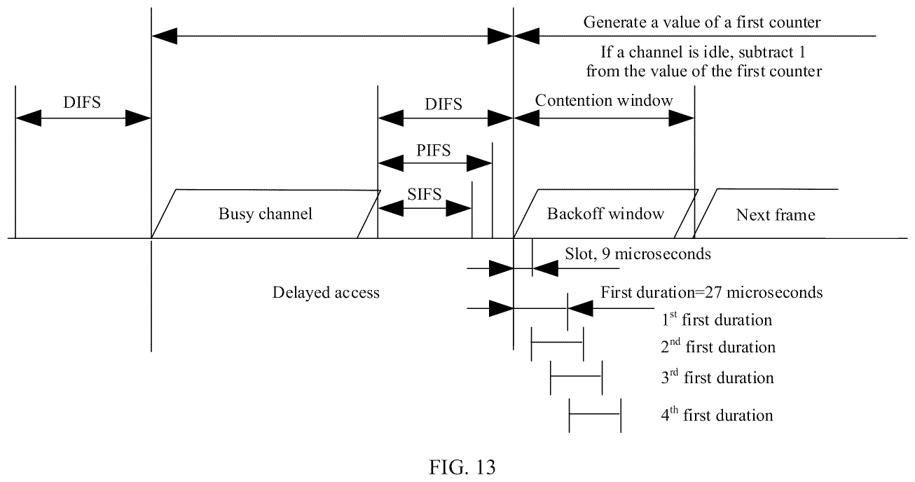

For example, as shown in FIG. 13, M may be 1, the first duration is 27 microseconds, and the second time unit is one slot. To be specific, the first device opens one channel detection window of the first duration at an interval of one slot (9 microseconds). If the first device may open three channel detection windows of first duration at the same time, and a channel state determined by each channel detection window is the idle state, the first device may subtract 1 from the random count value each time, and the three channel detection windows may be decreased by three times, which is equivalent to subtraction of 3. This is equivalent to technical effect of performing fast backoff by using M=3 in FIG. 11 in the foregoing embodiment.

It should be noted that a quantity of channel detection windows, that is, sliding windows used to detect the channel statuses in parallel, opened by the first device needs to be implemented based on a capability of the first device. For example, a quantity of sliding windows may be 3, 4, or 5. This is not limited in this application.

In another implementation, if the current frame corresponds to a point coordination function inter-frame space of long range (PIFSLR) or a distributed coordination function inter-frame space of long range (DIFSLR), the first device may occupy, after a short inter-frame space SIFS, an idle slot. In other words, some slots of the PIFS of the long range or the DIFS of the long range are occupied, to open, in advance, the plurality of parallel channel detection windows generated in a sliding manner.

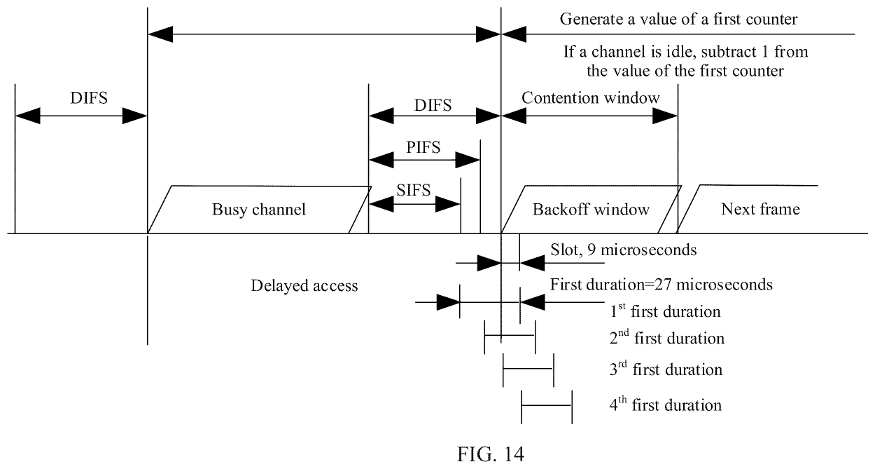

For example, the second time unit is one slot. As shown in FIG. 14, after the SIFS, the first device may start a 1^{st} channel detection window of the first duration to detect the channel status. Therefore, a 2^{nd} channel detection window of the first duration is opened in a 2^{nd} slot after the SIFS, and a 3^{rd} channel detection window of the first duration is opened in a 3^{rd} slot after the SIFS. The rest may be deduced by analogy.

S1203: If the value of the first counter is less than or equal to 0, the first device transmits data through the channel.

In an implementation, the first device may send a long range physical layer protocol data unit PPDU through the channel.

In the foregoing technical implementation, the sliding window manner is used. After the start moment of the 1^{st} channel detection window of the first duration, one channel detection window is opened at the interval of the second time unit, so that the long range device can open the plurality of channel detection windows in parallel, and detect the channel statuses at the same time. If it is detected in one channel detection window that a current channel is in the idle state, M may be subtracted from the value of the first counter. When it is detected in the plurality of channel detection windows that the current channel is in the idle state, M may be subtracted from the value of the first counter for a plurality of times. This accelerates CCA detection frequency and a backoff speed of the long range device, so that the first counter can be quickly back off to 0 or a value less than 0, thereby accelerating a backoff speed of a long range transmission node. This ensures fairness of random channel contention performed by the long range transmission node, and improves transmission efficiency of the long range device.

In addition, an embodiment of this application further provides a channel access method, used for trigger-based long range transmission. The method is applied to trigger-based data transmission between a second device and a third device. The second device may be an AP or a STA, and the third device may be a STA or an AP. In other words, the following implementation may be applied to a scenario in which the AP triggers one or more STAs to send uplink data, or may be applied to a scenario in which the STA triggers one or more APs to send downlink data. Usually, the AP triggers the STA to send the uplink data. Therefore, in this embodiment of this application, only an example in which the second device is the AP and the third device is the STA is used to describe the solution, but this does not constitute a limitation on the protection scope of this application.

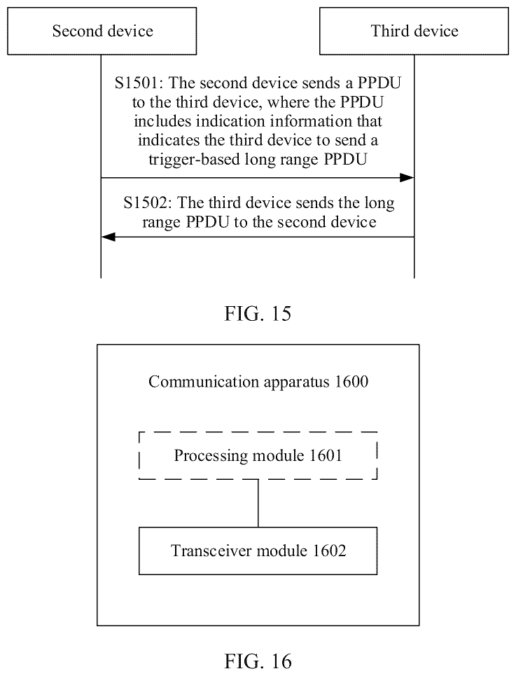

As shown in FIG. 15, the method may include the following steps.

S1501: The second device sends a PPDU to the third device, where the PPDU includes indication information that indicates the third device to send a trigger-based long range PPDU.

In an implementation, the second device may contend for a channel by using aSlotTime and aCCATime that are defined in the existing standard. The second device sends the PPDU including the indication information to the third device, to indicate that the third device may send the trigger-based long range PPDU.

In other words, the PPDU including the indication information is equivalent to a trigger frame, and is used to trigger the long range PPDU. Therefore, the third device may send the uplink data based on a resource indicated by the PPDU of the second device, and is not allowed to contend for the channel in the foregoing random access manner.

For example, the second device may be an AP, and the third device may be a STA.

Optionally, it may be further specified that, that a long range STA performs long range transmission needs to be triggered by the AP instead of contending for the channel by using CSMA/CA, to obtain a transmission opportunity. In this way, for the AP, if long range transmission is not actively triggered by the AP, the AP does not receive a long range PPDU sent by a STA in a local cell. Even if the AP uses an existing contention backoff method, the AP does not miss a long range PPDU sent by another STA in the local cell.

In other words, in this implementation scenario, if the AP does not trigger long range transmission, the STA cannot actively implement long range transmission, and the STA needs to implement long range transmission based on triggering of the AP. For another STA that transmits a non-long range PPDU, the PPDU may be sent by using an existing random channel contention mechanism.

The indication information may be carried in an extended signaling field or a data field of the PPDU.

For example, 1 bit is used to carry the indication information in the extended signaling field of the PPDU. If the indication information is set to 1, it indicates that the third device is triggered to send the trigger-based long range PPDU. If the indication information is set to 0, it indicates that the third device is not triggered to send the trigger-based long range PPDU.

If a fixed bandwidth (for example, 20 MHz) and a fixed minimum bit rate are usually used for the long range transmission, the 1-bit indication information may indicate to trigger the long range PPDU. In an implementation, the indication information may further include indications such as an uplink bandwidth (for example, a resource unit size), and an uplink modulation and coding scheme. In this case, the indication information may be further carried in the extended signaling field of the PPDU sent by the second device to the third device.

In an implementation, the indication information may alternatively be carried in the data field of the long range PPDU. Because only limited information needs to be provided for triggering the third device to perform long range transmission, a trigger frame with low overheads may be designed to reduce signaling overheads of the long range transmission.

Alternatively, in another implementation, explicit indication may not be performed via the indication information. It may be preconfigured as follows: If the STA receives a downlink long range PPDU, and if the uplink data needs to be transmitted, the STA may send the uplink data; or if there is no uplink data, the STA may reply only with acknowledgment information to the AP.

Correspondingly, the third device receives the PPDU from the second device, and obtains the indication information carried in the PPDU.

S1502: The third device sends the long range PPDU to the second device.

Specifically, the third device may send the long range PPDU to the second device based on the indication information. The third device is not allowed to contend for the channel in the foregoing random access manner, and the long range PPDU sent by the third device is sent based on a time-frequency resource indicated in the PPDU of the second device.

Correspondingly, the second device receives the long range PPDU from the third device.

In the foregoing implementation, the indication information indicating to trigger the long range PPDU is added to the PPDU, so that the trigger frame with the low overheads is implemented, and the overheads of the long range transmission are reduced. In this way, a receive end may send the long range PPDU based on the trigger frame, thereby improving communication efficiency of the long range transmission. In addition, the foregoing trigger-based long range PPDU transmission does not affect an existing random backoff mechanism of a node, and a change to the random backoff mechanism is small, which is easy to implement.

Based on the foregoing implementations, this application further provides a communication apparatus, configured to perform the method performed by the access point or the station in the foregoing embodiments.

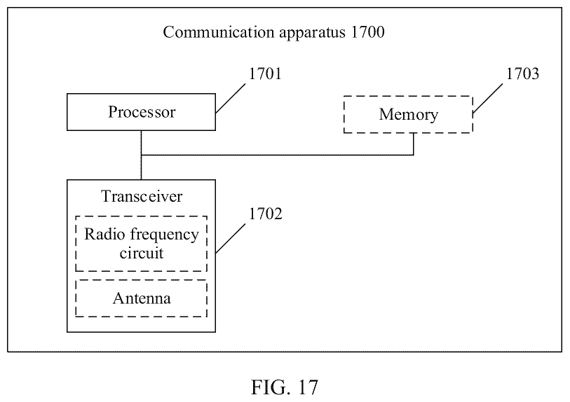

As shown in FIG. 16, the communication apparatus 1600 includes a processing module 1601 and a transceiver module 1602. The communication apparatus 1600 may be configured to implement the method performed by the first device in the implementation shown in FIG. 9.

The processing module 1601 is configured to detect a channel status in first duration.

If the channel is in an idle state, the processing module 1601 is further configured to subtract M from a value of a first counter, where M is a positive integer greater than 1. If the value of the first counter is greater than 0, the processing module 1601 is configured to detect the channel status in next first duration.

If the value of the first counter is less than or equal to 0, the transceiver module 1602 is configured to transmit data through the channel.

In an implementation, the first duration is greater than duration of a first time unit, and the first time unit is one slot.

In an implementation, the processing module 1601 is configured to: after waiting for a first inter-frame gap, detect the channel status in the first duration, and the first inter-frame gap is a point coordination function inter-frame space PIFS of long range, a short inter-frame space SIFS, or a distributed coordination function inter-frame space DIFS of long range.

In an implementation, the processing module 1601 is configured to detect the channel status in next first duration after an end moment of the first duration.

In an implementation, the long rangePIFS of long range is a sum of the SIFS and the first duration.

In an implementation, the long rangeDIFS of long range is a sum of the SIFS and twice the first duration.

In an implementation, the transceiver module 1602 is configured to send a long range physical layer protocol data unit PPDU through the channel.

As shown in FIG. 16, the communication apparatus 1600 includes a processing module 1601 and a transceiver module 1602. The communication apparatus 1600 may be configured to implement the method performed by the first device in the implementation shown in FIG. 12.

The processing module 1601 is configured to: detect a channel status in first duration, and if a channel status is in an idle state, subtract M from a value of a first counter, where M is a positive integer.

The processing module 1601 is further configured to: open one channel detection window of the first duration at an interval of a second time unit after a start moment of the first duration, detect the channel status in the channel detection window, and if the channel status is the idle state, subtract M from the value of the first counter, where M is the positive integer.

If the value of the first counter is less than or equal to 0, the transceiver module 1602 is configured to transmit data through the channel.

In an implementation, duration of the channel detection window is equal to the first duration.

In an implementation, the first duration is greater than duration of a first time unit, and the first time unit is one slot.

In an implementation, if a current frame corresponds to a point coordination function inter-frame space PIFS of long range or a distributed coordination function inter-frame space DIFS of long range, the processing module 1601 is configured to: after a short inter-frame space SIFS, start to detect the channel status in the first duration.

In an implementation, the transceiver module 1602 is further configured to send a long range physical layer protocol data unit PPDU through the channel.

As shown in FIG. 16, the communication apparatus 1600 includes a transceiver module 1602. The communication apparatus 1600 may be configured to implement the method performed by the second device in the implementation shown in FIG. 15.

The transceiver module 1602 is configured to send a physical layer protocol data unit PPDU to a third device. The PPDU includes indication information, and the indication information indicates the third device to send a trigger-based long range PPDU.

The transceiver module 1602 is further configured to receive the long range PPDU from the third device.

In an implementation, the indication information is carried in an extended signaling field or a data field of the PPDU.

As shown in FIG. 16, the communication apparatus 1600 includes a transceiver module 1602. The communication apparatus 1600 may be configured to implement the method performed by the third device in the implementation shown in FIG. 15.

The transceiver module 1602 is configured to receive a physical layer protocol data unit PPDU from a second device. The PPDU includes indication information, and the indication information indicates the communication apparatus 1600 to send a trigger-based long range PPDU.

The transceiver module 1602 is further configured to send the long range PPDU to the second device.

In an implementation, the indication information is carried in an extended signaling field or a data field of the PPDU.

In this application, the foregoing access point or station may be presented in a form of obtaining each function module through division in an integrated manner. The “module” herein may be an application-specific integrated circuit (application-specific integrated circuit, ASIC), a circuit, a processor and a memory that execute one or more software or firmware programs, an integrated logic circuit, and/or another component that can provide the foregoing functions.

The communication apparatus 1600 provided in this embodiment of this application may be an independent device or may be a part of a large device. For example, the communication apparatus 1600 may be:
(1) an independent integrated circuit IC, a chip, or a chip system or subsystem;
(2) a set that has one or more ICs, where optionally, the IC set may alternatively include a storage component configured to store data and instructions;
(3) an ASIC, for example, a modem (modem);
(4) a module that can be embedded in another device;
(5) a receiver, an intelligent terminal, a wireless device, a handset, a mobile unit, a vehicle-mounted device, a cloud device, an artificial intelligence device, or the like; or
(6) others.

In some embodiments, in hardware implementation, a person skilled in the art may figure out that the target station may be in a form of the communication apparatus 800 shown in FIG. 8.

Because the access point or station provided in embodiments may perform the foregoing method, for technical effect that can be achieved by the access point or station, refer to the foregoing method embodiments. Details are not described herein again.

In a possible product form, the access point and the station in embodiments of this application may alternatively be implemented by using one or more field programmable gate arrays (field programmable gate array, FPGA), programmable logic devices (programmable logic device, PLD), controllers, state machines, logic gates, discrete hardware components, any other appropriate circuits, or any combination of circuits that can perform the various functions described in this application.

In some embodiments, an embodiment of this application further provides a communication apparatus. The communication apparatus includes a processor, configured to implement the method in any one of the foregoing method embodiments.

In a possible implementation, the communication apparatus further includes a memory. The memory is configured to store necessary program instructions and necessary data. The processor may invoke program code stored in the memory, to indicate the communication apparatus to perform the method in any one of the foregoing method embodiments. Certainly, the communication apparatus may not include a memory.

In another possible implementation, the communication apparatus further includes an interface circuit. The interface circuit is a code/data read/write interface circuit, and the interface circuit is configured to receive computer-executable instructions (where the computer-executable instructions are stored in a memory, and may be directly read from the memory, or may be read via another component) and send the computer-executable instructions to the processor.

In still another possible implementation, the communication apparatus further includes a communication interface, and the communication interface is configured to communicate with a module other than the communication apparatus.

It may be understood that the communication apparatus may be a chip or a chip system. When the communication apparatus is a chip system, the communication apparatus may include a chip, or may include a chip and another discrete component. This is not specifically limited in embodiments of this application.

In some embodiments, an embodiment of this application further provides a communication apparatus (for example, the communication apparatus may be a chip or a chip system). The communication apparatus includes an interface circuit and a logic circuit. The interface circuit is configured to obtain input information and/or output output information; and the logic circuit is configured to perform the method performed by the access point or station in any one of the foregoing method embodiments.

In a possible product form, the access point and the station in embodiments of this application may be implemented by using general bus architectures.

For ease of description, FIG. 17 is a diagram of a structure of a communication apparatus 1700 according to an embodiment of this application. The communication apparatus 1700 includes a processor 1701 and a transceiver 1702. The communication apparatus 1700 may be an access point, a target station, or a chip thereof. FIG. 17 shows only main components in the communication apparatus 1700. In addition to the processor 1701 and the transceiver 1702, the communication apparatus may further include a memory 1703 and an input/output apparatus (which is not shown in the figure).

The processor 1701 is mainly configured to: process a communication protocol and communication data, control the entire communication apparatus, execute a software program, and process data of the software program. The memory 1703 is mainly configured to store the software program and the data. The transceiver 1702 may include a radio frequency circuit and an antenna. The radio frequency circuit is mainly configured to: perform conversion between a baseband signal and a radio frequency signal, and process the radio frequency signal. The antenna is mainly configured to send and receive a radio frequency signal in a form of an electromagnetic wave. An input/output apparatus, for example, a touchscreen, a display, a keyboard, or the like is mainly configured to: receive data input by a user, and output data to the user.

The processor 1701, the transceiver 1702, and the memory 1703 may be connected through a communication bus.

After the communication apparatus is powered on, the processor 1701 may read the software program in the memory 1703, interpret and execute instructions of the software program, and process the data of the software program. When data needs to be sent wirelessly, the processor 1701 performs baseband processing on the to-be-sent data, and then outputs a baseband signal to the radio frequency circuit. The radio frequency circuit performs radio frequency processing on the baseband signal, and then sends a radio frequency signal to the outside in a form of electromagnetic wave through the antenna. When data is to be sent to the communication apparatus, the radio frequency circuit receives a radio frequency signal through the antenna, converts the radio frequency signal into a baseband signal, and outputs the baseband signal to the processor 1701. The processor 1701 converts the baseband signal into data, and processes the data.

In another implementation, the radio frequency circuit and the antenna may be disposed independently of a processor that performs baseband processing. For example, in a distributed scenario, the radio frequency circuit and the antenna may be remotely disposed independent of the communication apparatus.

It should be understood that sequence numbers of the foregoing processes do not mean execution sequences in various embodiments of this application. The execution sequences of the processes should be determined based on functions and internal logic of the processes, and should not be construed as any limitation on the implementation processes of embodiments of this application.

A sequence of the steps of the method in embodiments of this application may be adjusted, combined, or removed based on an actual requirement.

The modules in the apparatus in embodiments of this application may be combined, divided, and deleted based on an actual requirement.

In this application, unless otherwise specified, for same or similar parts of embodiments, refer to each other. In embodiments of this application and the implementations/implementation methods in embodiments, unless otherwise specified or a logical conflict occurs, terms and/or descriptions are consistent and may be mutually referenced between different embodiments and between the implementations/implementation methods in embodiments. Technical features in different embodiments and the implementations/implementation methods in embodiments may be combined to form a new embodiment, implementation, or implementation method based on an internal logical relationship thereof. The foregoing implementations of this application are not intended to limit the protection scope of this application.

It may be understood that, in some scenarios, some optional features in embodiments of this application may be independently implemented without depending on another feature, for example, a solution on which the optional features are currently based, to resolve a corresponding technical problem and achieve corresponding effect. Alternatively, in some scenarios, the optional features may be combined with other features based on requirements. Correspondingly, the apparatus provided in embodiments of this application may also correspondingly implement these features or functions. Details are not described herein.

All or some of foregoing embodiments may be implemented by using software, hardware, firmware, or any combination thereof. When a software program is used to implement embodiments, all or a part of embodiments may be implemented in a form of a computer program product. The computer program product includes one or more computer instructions. When the computer program instructions are loaded and executed on a computer, the procedure or functions according to embodiments of this application are all or partially generated. The computer may be a general-purpose computer, a special-purpose computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (digital subscriber line, DSL)) or wireless (for example, infrared, radio, or microwave) manner. The computer-readable storage medium may be any usable medium accessible by a computer, or a data storage device, for example, a server or a data center, integrating one or more usable media. The usable medium may be a magnetic medium (for example, a floppy disk, a hard disk, or a magnetic tape), an optical medium (for example, a DVD), a semiconductor medium (for example, a solid-state disk (solid-state disk, SSD)), or the like. In embodiments of this application, the computer may include the foregoing apparatuses.

Although this application is described with reference to embodiments, in a process of implementing this application that claims protection, a person skilled in the art may understand and implement another variation of the disclosed embodiments by viewing the accompanying drawings, disclosed content, and appended claims. In the claims, “comprising” (comprising) does not exclude another component or another step, and “a” or “one” does not exclude a case of “a plurality of”. A single processor or another unit may implement several functions enumerated in the claims. Some measures are recorded in dependent claims that are different from each other, but this does not mean that these measures cannot be combined to produce better effect.

Although this application is described with reference to specific features and embodiments thereof, it is clearly that various modifications and combinations may be made to them without departing from the spirit and scope of this application. Correspondingly, the specification and accompanying drawings are merely example description of this application defined by the appended claims, and are considered as any of and all modifications, variations, combinations or equivalents that cover the scope of this application. It is clearly that a person skilled in the art can make various modifications and variations to this application without departing from the spirit and scope of this application. This application is intended to cover these modifications and variations of this application provided that they fall within the scope of protection defined by the following claims and their equivalent technologies.

What is claimed is:

1. A channel access method, wherein the method comprises:
detecting a channel status in first duration; and
if the channel status is in an idle state, subtracting M from a value of a first counter, wherein M is a positive integer greater than 1; and
if the value of the first counter is greater than 0, detecting the channel status in next first duration; or
if the value of the first counter is less than or equal to 0, transmitting data through a channel.

2. The method according to claim 1, wherein the first duration is greater than duration of a first time unit, and the first time unit is one slot.

3. The method according to claim 1, wherein before the detecting a channel status in first duration, the method further comprises:
waiting for a first inter-frame gap, wherein the first inter-frame gap is a point coordination function inter-frame space (PIFS) of long range, a short inter-frame space (SIFS), or a distributed coordination function inter-frame space (DIFS) of long range.

4. The method according to claim 3, wherein the PIFS of long range is a sum of the SIFS and the first duration.

5. The method according to claim 3, wherein the DIFS of long range is a sum of the SIFS and twice the first duration.

6. The method according to a claim 1, wherein the detecting the channel status in next first duration specifically comprises:
detecting the channel status in the next first duration after an end moment of the first duration.

7. The method according to claim 1, wherein the method further comprises:
sending a long range physical layer protocol data unit (PPDU) through the channel.

8. A communication apparatus, wherein the communication apparatus comprises a processor and a transceiver;
the processor is configured to detect a channel status in first duration; and
if the channel is in an idle state, the processor is further configured to subtract M from a value of a first counter, wherein M is a positive integer greater than 1; and
if the value of the first counter is greater than 0, the processor is configured to detect the channel status in next first duration; or
if the value of the first counter is less than or equal to 0, the transceiver is configured to transmit data through the channel.

9. The apparatus according to claim 8, wherein the first duration is greater than duration of a first time unit, and the first time unit is one slot.

10. The apparatus according to claim 8, wherein the processor is configured to: after waiting for a first inter-frame gap, detect the channel status in the first duration, and the first inter-frame gap is a point coordination function inter-frame space (PIFS) of long range, a short inter-frame space (SIFS), or a distributed coordination function inter-frame space (DIFS) of long range.

11. The apparatus according to claim 10, wherein the PIFS of long range is a sum of the SIFS and the first duration.

12. The apparatus according to claim 10, wherein the DIFS of long range is a sum of the SIFS and twice the first duration.

13. The apparatus according to claim 8, wherein the processor is configured to detect the channel status in next first duration after an end moment of the first duration.

14. The apparatus according to claim 8, wherein the transceiver is configured to send a long range physical layer protocol data unit (PPDU) through the channel.

15. A computer-readable storage medium, wherein the computer-readable storage medium comprises a computer program, and when the computer program is run on a computer, the computer is enabled to perform a method as below:
detecting a channel status in first duration; and
if the channel status is in an idle state, subtracting M from a value of a first counter, wherein M is a positive integer greater than 1; and
if the value of the first counter is greater than 0, detecting the channel status in next first duration; or
if the value of the first counter is less than or equal to 0, transmitting data through a channel.

16. The computer-readable storage medium according to claim 15, wherein the first duration is greater than duration of a first time unit, and the first time unit is one slot.

17. The computer-readable storage medium according to claim 15, wherein before the detecting a channel status in first duration, the method further comprises:
waiting for a first inter-frame gap, wherein the first inter-frame gap is a point coordination function inter-frame space (PIFS) of long range, a short inter-frame space (SIFS), or a distributed coordination function inter-frame space (DIFS) of long range.

18. The computer-readable storage medium according to claim 17, wherein the PIFS of long range is a sum of the SIFS and the first duration.

19. The computer-readable storage medium according to claim 17, wherein the DIFS of long range is a sum of the SIFS and twice the first duration.

20. The computer-readable storage medium according to a claim 15, wherein the detecting the channel status in next first duration specifically comprises:
detecting the channel status in the next first duration after an end moment of the first duration.
